(19) United States
(12) Patent Application Publication
(10) Pub. No.: US 2002/0064673 A1
(43) Pub. Date: May 30, 2002

(54) Antiskid composition and method for preparation thereof

(76) Inventors: Bruce Hale, Nokomis, FL (US); Bo Larsson, Savepupen (SE)

Correspondence Address: Lainie E. Parker, Akzo Nobel Inc., 7 Livingstone Avenue, Dobbs Ferry, NY, 10522, US

(21) Appl. No.: 09/950,477

(22) Filed: Sep. 10, 2001

Related U.S. Application Data
(63) Continuation-in-part of application No. 09/659,485, filed on Sep. 11, 2000.

(51) Int. Cl. B32B 9/04

(52) U.S. Cl. 428/537.5; 428/447; 428/446

(57) ABSTRACT

The present invention relates to a method for increasing the friction of a cellulosic material, wherein the cellulosic material is coated with a substantially latex-free aqueous antiskid composition comprising at least an aluminate modified silica sol. It also relates to a cellulosic material at least partially coated with the composition. The invention also relates to said composition and the preparation thereof.

The invention relates to an aqueous antiskid composition intended to increase the friction of cellulosic material in order to prevent sliding thereof. More specifically, the invention relates to a substantially latex-free composition comprising an aluminate modified silica sol and a method for preparation thereof. The invention further relates to a cellulosic material coated with said composition and a method of increasing the friction of a cellulosic material coated with such a composition.

### BACKGROUND OF THE INVENTION

It is in many instances advantageous to employ paper products having enhanced friction on the surface, e.g. paperboard liner for cardboard boxes containing goods susceptible to damage in the event a stack of boxes topples. Another common example where frictionisers or antiskid products have proved useful include bags or the like piled in a truck or other vehicle liable to sliding.

Previously, silica sol compositions have been applied on paper product surfaces as frictionisers or antiskid products in order to reduce sliding.

U.S. Pat. No. 5,466,493 discloses an antiskid composition for paper products comprising colloidal silica sol and/or colloidal alumina, and other organic additives improving the cleanability of the paper product. However, fairly large dosages of silica or alumina sols are needed to provide a paper material with a high slide angle

GB 1 344 288 describes an aluminium-borate coated silica sol, which may be used in antiskid applications. However, the aluminium-borate coating on the silica sol gives rise to corrosion of the paper machinery. The boric-acid stabilised basic alumina acetate or formate complexes used to obtain the aluminium borate coating are also fairly expensive and must be added at rather high levels to obtain a stable, silica sol product.

WO99/39838 relates to an antiskid composition comprising latex, an alcohol, and colloidal silica. Latexes comprise natural or synthetic water insoluble polymers. Such latex compositions are normally sticky and may easily stick to paper treating equipment rather than imparting a good cleanliness, even in the presence of colloidal silica products. This causes handling problems of the paper treating equipment. Moreover, a dispersing agent may in many cases be needed to suspend water insoluble latexes sufficiently in an aqueous antiskid composition, which makes the latex compositions fairly expensive and complex to handle which eventually results in a costly antiskid product.

The present invention intends to solve the above problems.

### THE INVENTION

The present invention relates to a method for increasing the friction of a cellulosic material by coating the cellulosic material with a substantially latex-free aqueous antiskid composition comprising at least an aluminate modified silica sol.

It has been surprisingly found that it is possible to reduce the dosage of a colloidal silica sol to a cellulosic material by providing a substantially latex-free antiskid composition comprising an aluminate modified colloidal silica sol and suitably at least one organic additive. Moreover, it has been found that the aluminate modified silica sol composition of the invention does not cause any substantial deposit problems in contrast to latex-containing conventional silica sol-based compositions, partly as a result of the aluminate modified silica sol compositions being more stable. In fact, aluminate modified silica sol particles may remain stable down to a pH of about 3 due to their capability of remaining their negative charge.

By the term “cellulosic material” is meant any virgin or recycled paper or paperboard material such as linerboard, corrugated board, or liquid board. The cellulosic material may be made from unbleached soft wood kraft pulp, sulfite and ground wood pulp blends, ground wood, and bleached kraft blends.

By the term “substantially latex-free composition” means a composition containing at the most only trace amounts of latex, which may be present as contaminants. In some cases such trace amount may be up to about 1000 ppm, but in most cases up to about 100 ppm.

It has further been surprisingly found that the drawbacks referred to above can be avoided by the present invention without reducing the friction of a coated cellulosic material or other advantageous effects.

Addition of the antiskid composition to the cellulosic material is suitably performed in the paper stock, preferably by means of spraying, roll coating, sponge application or use of a doctor blade. The composition can be added to the size press or to the wet calender stack or other parts of a paper machine. The quantity of the antiskid composition applied to the cellulosic material is subject to variation, but suitably from about 0.05 to about 1.5, preferably from about 0.15 to about 0.5 grams per m² of cellulosic material is added.

The antiskid composition can also be applied to other materials than cellulosic material, e.g. textiles and other felted, woven or nonwoven material and in other applications where antislip resistance is desired.

The aluminate modified silica sol, also sometimes referred to as aluminium modified silica sol, can be prepared by adding an appropriate amount of aluminate ions, Al(OH)₄⁻¹, suitably of diluted sodium or potassium aluminate to a conventional non-inserted or exchanged aluminate ions, thus creating an aluminosilicate site having a fixed negative charge. The aluminate modified silica particles remain their negative charge down to pH 3 in contrast to conventional non-modified silica sols remaining negatively charged only down to pH 7 The pH of the modified silica sol can be adjusted, preferably by means of an ion exchange resin, suitably to a pH ranging from about 4 to about 11, preferably from about 5.5 to about 9.5. The aluminate modified silica sol can thereafter be concentrated to yield a silica content from about 5 to about 60 wt %, preferably from about 15 to about 45 wt %. The aluminate modified silica particles suitably have an Al₂O₃ content of from about 0.05 to about 1.5 wt %, preferably from about 0.1 to about 0.6 wt %. The diameter of the aluminate modified silica particles suitably ranges from about 5 to about 100 nm, preferably from about 20 nm to about 60 nm. The specific surface area of the aluminate modified silica particles suitably ranges from about 25 to about 500 m²/g, preferably from about 40 to about 140 m²/g. The procedure of preparing aluminate modified silica sol is further described e.g. in “The Chemistry of Silica”, by Iler, K. Ralph, pages 407-408, John Wiley & Sons (1979) and in U.S. Pat. No. 5,368,833. The negatively charged aluminate modified silica particles are distinguished from alumina coated silica particles, because alumina coated silica particles have their surface coated (covered) with a layer of alumina resulting in positively charged particles acting as though they were alumina particles.

Suitably, the antiskid composition contains from about 5 to about 60 wt % silica particles, preferably from about 15 to about 45 wt %.

The aqueous antiskid composition further suitably comprises at least one organic additive. The organic additive or mixture of additives is primarily comprised in the composition to enhance the cleanability of the paper machinery. The additive can be present in appropriate amounts in the composition, suitably in a concentration from about 1 to about 40 wt %, preferably from about 7 to about 15 wt %. The additive can be selected from the group consisting of amines such as triethanolamine, diethanolamine, monoethanolamine, diethylaminoethanol, urea, alcohols such as polyols, glycerine, ethylene glycol, diethylene glycol, polyhydroxy compounds or sugars such as fructose, glucose, lactose, lactose invert sugar, sucrose, sorbitol, mannitol, galactitol, saccharose, raffinose, fructose, and hydrolysates of starch or cellulose. The organic additive is preferably selected from glycerine, triethanolamine, and sorbitol, and most preferably from glycerine.

The aqueous antiskid composition can also comprise a biocide, especially in the event a polyhydroxy compound is present liable to microbiological attack. Suitable biocides include e.g. glutaraldehyde, hydrogen peroxide, and methyl p-hydroxybensoate or mixtures thereof.

According to one preferred embodiment, the antiskid composition contains from about 5 to about 60 wt % aluminate modified silica particles, from about 1 to about 20 wt % glycerine, from about 1 to about 20 wt % sorbitol, and from about 0.1 to about 5 wt % triethanolamine.

According to another preferred embodiment, the antiskid composition comprises from about 5 to about 60 wt %, preferably from about 15 to about 45 wt % silica particles, from about 1 to about 20 wt %, preferably from about 5 to about 15 wt % glycerine, from about 1 to about 20 wt %, preferably from about 3 to about 10 wt % sorbitol, from about 0.1 to about 5 wt %, preferably from about 0.5 to about 1 wt % triethanolamine. A biocide may also be present in the composition in a concentration from about 0.01 to about 0.5 wt %, preferably from about 0.05 to about 0.1 wt %.

The invention further relates to a cellulosic material at least partly coated with an aqueous substantially latex-free composition comprising an aluminate modified silica sol, and suitably at least one organic additive as described herein.

The present invention also relates to a substantially latex-free aqueous antiskid composition comprising an aluminate modified colloidal silica sol and at least one organic additive soluble therein as described above. The antiskid composition primarily intends to impart increased friction to cellulosic material, thereby reducing sliding of such cellulosic material. It has been surprisingly found that the composition of the present invention enables lower dosage rates of silica than do unmodified silica sol compositions for the same degree of enhanced friction of a coated cellulosic material as well as a lower degree of deposits. The antiskid composition of the present invention also meets the need of providing an antiskid composition which is easy to apply and to clean up. Furthermore, the composition is noncorrosive, nontoxic, nonsticky, and does not interfere with the ability to recycle the paper to which it has been coated.

The invention also relates to a method for preparing a substantially latex-free aqueous antiskid composition comprising an aluminate modified silica sol and at least one organic additive soluble therein. The organic additive may be selected from the group consisting of any of the above enumerated organic compounds, i.e. amines such as triethanolamine, diethanolamine, monoethanolamine, urea, alcohols such as polyols, glycerine, ethylene glycol, diethylene glycol, diethylaminoethanol, hydrolysates of starch or cellulose, polyhydroxy compounds or sugar e.g. fructose, glucose, lactose, sucrose, sorbitol, mannitol, galactitol, saccharose, raffinose, fructose, lactose invert sugar, or mixtures thereof. The preparation of the antiskid composition can be made by mixing the components making up the antiskid composition in any order in water or neat. The additives may be readily dispersed in the aluminate modified silica sol. This can be accomplished by simply adding the additive or mixture of additives to the modified silica sol under stirring or agitation. The mixing temperature, time of mixing are not critical parameters for the preparation of the composition. Suitably, the mixing temperature is from about 5 to about 50° C., preferably from about 10 to about 30° C. Suitably, the mixing time is from about 5 to about 180 minutes, preferably from about 30 to about 90 minutes.

The invention being thus described, it will be obvious that the same may be varied in many ways. Such variations are not to be regarded as a departure from the gist and scope of the present invention, and all such modifications as would be obvious to one skilled in the art are intended to be included within the scope of the claims. The following examples will further illustrate how the described invention may be performed without limiting the scope of it. If not otherwise stated, all parts and percentages refer to parts and percent by weight.

### EXAMPLE 1

Two aqueous silica sol-based compositions were prepared. Composition A contained a silica sol-based antiskid composition comprising 40 wt % silica particles and organic additives constituting less than 1 %. Composition B contained an aluminate modified silica sol composition comprising 35 wt % silica particles, 0.2 wt % aluminate, 13 wt % organic additives comprising glycerin, sorbitol, and triethanolamine. The organic additives were added in order to improve the cleanability of the paper machinery without influencing the degree of slide angle in the compositions A and B. The compositions A and B were applied to kraft liner board by spraying. Thereafter, the slide angle was measured according to Tappi method no. T 815 om-95. The Tappi method involves an inclinable plane having a smooth incompressible surface hinged so that it can be variably tilted, to which the test specimen is mounted and clamped in place with the coated surface facing downwards. The angle of decline is increased till the sledge starts to move, i.e. when the slide angle is reached. The procedure is reproduced three times, and the reading of the third slide angle is noted.

| | Amount applied (kg/ton | Slide angle |
|---|---|---|
| Antiskid product | paper pulp) | (average) |
| Silica sol-based antiskid | 0.93 | 26.0 |
| composition | | |
| Silica sol-based antiskid | 0.93 | 25.8 |
| composition | | |
| Silica sol-based antiskid | 0.93 | 26.2 |
| composition | | |
| Aluminate modified silica sol | 0.86 | 27.7 |
| composition | | |
| Aluminate modified silica sol | 0.77 | 270 |
| composition | | |
| Aluminate modified silica sol | 0.85 | 29.2 |
| composition | | |
| Aluminate modified silica sol | 0.60 | 26.3 |
| composition | | |
| Aluminate modified silica sol | 0.70 | 27.0 |
| composition | | |

In view of the results above, it can be clearly seen that the aluminate modified silica sol composition contribute to a significant slide angle win compared to the silica sol composition, even at a lower dosage rate, and with a lower SiO₂ content in the aluminate modified silica sol.

### EXAMPLE 2

Two aqueous silica sol-based antiskid compositions were prepared. Composition C contained 34 wt % silica, and 10.5 wt % organic additives selected from sorbitol and glycerine. Composition D, being an aluminated modified silica sol-based composition, contained 35 wt % silica, 0.2 wt % Al₂O₃, and 13 wt % organic additives selected from glycerine, sorbitol, and triethanolamine. The compositions were applied to liquid packaging board via a waterbox on the paper machine calendar. The Tappi standard test was performed as described in example 1.

| | Amount applied (kg/ton | |
|---|---|---|
| Antiskid composition | paper) | Slide angle |
| Silica sol-based antiskid | 0.59 | 16.0 |
| composition | | |
| Silica sol-based antiskid | 0.59 | 16.0 |
| composition | | |
| Silica sol-based antiskid | 0.59 | 15.5 |
| composition | | |
| Silica sol-based antiskid | 0.59 | 17.0 |
| composition | | |
| Silica sol-based antiskid | 0.59 | 15.0 |
| composition | | |
| Aluminate modified silica sol | 0.59 | 22.9 |
| composition | | |
| Aluminate modified silica sol | 0.59 | 20.0 |
| composition | | |
| Aluminate modified silica sol | 0.59 | 20.4 |
| composition | | |

It can be clearly seen that the use of an aluminate modified silica sol significantly imparts an increased slide angle to the cellulosic material compared to the non-modified silica sol.

1. Method for increasing the friction of a cellulosic material, wherein the cellulosic material is coated with a substantially latex-free aqueous antiskid composition comprising at least an aluminate modified silica sol.

2. Method according to claim 1, wherein the antiskid composition comprises at least one organic additive soluble therein.

3. Method according to claim 1, wherein the aluminate modified silica particles contain from about 0.05 to about 1.5 wt % Al₂O₃.

4. Method according to claim 1, wherein the composition contains from about 5 to about 60 wt % silica particles.

5. Method according to claim 1, wherein the diameter of the aluminate modified silica particles ranges from about 5 to about 100 nm.

6. Method according to claim 1, wherein the aluminate modified silica particles have a specific surface area from about 25 to about 500 m²/g.

7. Method according to claim 1, wherein the organic additive is selected from the group consisting of amines, alcohols, polyhydroxy compounds or sugars, or mixtures thereof.

8. Method according to claim 1, wherein the composition comprises from about 1 to about 20 wt % of at least one organic additive.

9. Method according to claim 1, wherein the composition comprises glycerine.

10. Method according to claim 1, wherein the composition contains from about 5 to about 60 wt % aluminate modified silica particles, from about 1 to about 20 wt % glycerine, from about 1 to about 20 wt % sorbitol, and from about 0.1 to about 5 wt % triethanolamine.

11. Cellulosic material at least partially coated with an aqueous substantially latex-free antiskid composition comprising at least an aluminate modified silica sol.

12. Cellulosic material according to claim 11, wherein the antiskid composition comprises at least one organic additive soluble therein.

13. Cellulosic material according to claim 11, wherein the aluminate modified silica particles contain from about 0.05 to about 1.5 wt % Al₂O₃.

14. Cellulosic material according to claim 11, wherein the composition contains from about 5 to about 60 wt % silica particles.

15. Cellulosic material according to claim 11, wherein the diameter of the aluminate modified silica particles ranges from about 5 to about 100 nm.

16. Cellulosic material according to claim 11, wherein the aluminate modified silica particles have a specific surface area from about 25 to about 500 m²/g.

17. Cellulosic material according to claim 11, wherein the organic additive is selected from the group consisting of amines, alcohols, polyhydroxy compounds or sugars, or mixtures thereof.

18. Cellulosic material according to claim 11, wherein the composition comprises from about 1 to about 20 wt % of at least one organic additive.

19. Cellulosic material according to claim 11, wherein the composition comprises glycerine.

20. Cellulosic material according to claim 11, wherein the composition contains from about 5 to about 60 wt % aluminate modified silica particles, from about 1 to about 20 wt % glycerine, from about 1 to about 20 wt % sorbitol, and from about 0.1 to about 5 wt % triethanolamine.

21. Aqueous substantially latex-free antiskid composition comprising an aluminate modified silica sol and at least one organic additive soluble therein.

22. Composition according to claim 21, wherein the aluminate modified silica particles contain from about 0.05 to about 1.5 wt % Al₂O₃.

23. Composition according to claim 21, wherein the composition contains from about 5 to about 60 wt % silica particles.

24. Composition according to claim 21, wherein the diameter of the aluminate modified silica particles ranges from about 5 to about 100 nm.

25. Composition according to claim 21, wherein the aluminate modified silica particles have a specific surface area from about 25 to about 500 m²/g.

26. Composition according to claim 21, wherein the organic additive is selected from the group consisting of amines, alcohols, polyhydroxy compounds or sugars, or mixtures thereof.

27. Composition according to claim 21, wherein the composition comprises from about 1 to about 20 wt % of at least one organic additive.

28. Composition according to claim 21, wherein glycerine is comprised as an organic additive.

29. Composition according to claim 21, wherein the composition contains from about 5 to about 60 wt % aluminate modified silica particles, from about 1 to about 20 wt % glycerine, from about 1 to about 20 wt % sorbitol, and from about 0.1 to about 5 wt % triethanolamine.

30. Method for preparing an aqueous substantially latex-free antiskid composition according to claim 21, wherein an aluminate modified silica sol is mixed with at least one organic additive soluble therein.
